(19) United States
(12) Patent Application Publication
(10) Pub. No.: US 2005/0240491 A1
(43) Pub. Date: Oct. 27, 2005

(54) E-mail launched Web transaction

(76) Inventors: Jeff Greenberg, Delaplane, VA (US); Philip Kovilakath, Boca Raton, FL (US); Len Smith, Herndon, VA (US)

Correspondence Address: COOLEY GODWARD LLP;ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 11/159,117

(22) Filed: Jun. 23, 2005

Related U.S. Application Data
(63) Continuation-in-part of application No. 10/190,658, filed on Jul. 9, 2002.
Application No. 10/190,658 is a continuation-in-part of application No. 10/059,348, filed on Jan. 31, 2002.

(51) Int. Cl. G06F 17/60

(52) U.S. Cl. 705/26

(57) ABSTRACT

A method includes receiving, at a processor, an e-mail including a description of an offer and a selectable indicia configured to indicate acceptance of the offer in response to actuation of the selectable indicia. A browser is launched on a display coupled to the processor in response to actuation of the selectable indicia. An indication of acceptance of the offer to a transaction server in response to actuation of the selectable indicia is transmitted.

This application is a continuation-in-part of U.S. patent application Ser. No. 10/190,658, filed on Jul. 9, 2002, which is a continuation-in-part of U.S. patent application Ser. No. 10/059,348, filed on Jan. 31, 2002, the entirety of each of which is incorporated herein by reference.

### BACKGROUND OF THE INVENTION

The invention generally relates to electronic transactions, and more particularly to a method and apparatus for initiating a transaction from an electronic mail message.

In today's economy, electronic commerce is becoming a larger percentage of sales revenues for both traditional “bricks and mortar” merchants and electronic retailers (i.e., “e-tailers”). Such revenue is derived from the sales of good and services directly to consumers over the public, global Internet (and World Wide Web).

It is well known among traditional merchants attempting to boost sales by doing business over the Internet and e-tailers (collectively, “Internet merchants”) that the amount of time, mouse “clicks” and Web pages required for a consumer to complete a purchase over the Internet has a direct and dramatic effect on sales. Therefore, much effort has been expended in minimizing the amount of time and number of actions required for a consumer to make an Internet purchase. For example, U.S. Pat. No. 5,960,411 (“the '411 patent”), is directed to a method and system that allows an Internet purchase to be made with a single click of a user's mouse. While the '411 patent somewhat streamlines the purchasing process, it still suffers from the drawback that a user must first locate the desired item in order to place an order for it and thus does not streamline the purchase process to the fullest extent possible.

It is also well known among Internet merchants that sending electronic mail (e-mail) messages to customers that include links to specific merchant Web sites can be effective. While such e-mails direct traffic and provide a shortcut to a merchant's Web site, the user must click on the link to visit the merchant's Web site and then must still perform further actions in order to initiate and complete the transaction.

It is common for many merchant sites to employ an electronic shopping basket where visitors to the site (i.e., consumers) may view items and place those they wish to purchase before they “checkout.” The checkout process generally involves the consumer entering billing information, shipping information and certain preferences in order to complete the transaction and receive the good(s) and/or service(s) purchased.

What is needed is an e-mail launched Web transaction process that streamlines and further minimizes the amount of time and effort required to initiate and complete electronic commerce transactions.

### SUMMARY OF THE INVENTION

A method includes receiving, at a processor, an e-mail including a description of an offer and a selectable indicium, the actuation of which is configured to indicate acceptance of the offer in response to actuation of the selectable indicium. A browser is launched on a display coupled to the processor in response to actuation of the selectable indicia. An indication of acceptance of the offer to a transaction server in response to actuation of the selectable indicia is transmitted. In other embodiments of the invention, a method includes receiving at a transaction server customer information to create a customer account. A customer identification is transferred to a billing entity, the customer identification code being associated with the customer account. Billing information associated with the customer account is received from the billing entity. The billing information is encrypted and transmitted to a customer. An indication to make a payment to the billing entity is received from the customer.

### BRIEF DESCRIPTION OF THE DRAWINGS

FIG. 1 is a sequence diagram illustrating and e-mail creation and transfer process according to an embodiment of the invention.

FIG. 2A is a window or screen shot illustrating an example of an e-mail created during the e-mail creation and transfer process of FIG. 1.

FIG. 2B is a window or screen shot illustrating an example of an alternative e-mail created during the e-mail creation and transfer process of FIG. 1.

FIG. 2C is a window or screen shot illustrating an example of a further alternative e-mail created during the e-mail creation and transfer process of FIG. 1.

FIG. 3 is a sequence diagram illustrating an e-mail launched web transaction process, utilizing the e-mail of FIG. 2A, 2B or 2C, according to an embodiment of the invention.

FIG. 4 is a window or screen shot, according to an embodiment of the invention, of a confirmation of the transaction initiated from the e-mail of FIG. 2A or 2B.

FIG. 5 is a sequence diagram illustrating an e-mail launched web transaction process according to an embodiment of the invention.

FIG. 6 is a block diagram of an example of a computer system useful for implementing the invention.

### DETAILED DESCRIPTION

In an embodiment of the invention, an Internet merchant (or a marketing entity or service provider hired by an Internet merchant) selling particular good(s) and/or service(s) will initiate electronic commerce transactions from electronic mail (“e-mail”) messages. The merchant (or marketing entity) would, for example, provide the hardware (e.g., Web servers and electronic mail severs) and software (e.g., databases) infrastructure, application software, customer support, and billing mechanism to allow it to send such e-mail messages to consumers and complete the contemplated commercial transactions.

The invention is described in terms of the above example for convenient reference and is not intended to limit the application of the invention. In fact, after reading the following description, it will be apparent to one skilled in the relevant art(s) how to implement the following invention in alternative embodiments. For ease of understanding, certain method steps are delineated as separate steps; however, these steps should not be construed as necessarily distinct, nor order dependent in their performance. Specific details, such as types of transactions, types of data required for transactions, etc., are provided to provide a thorough understanding of the invention. The embodiments discussed herein should not be understood to limit the invention.

The terms “user,” “end user,” “consumer,” “shopper,” “customer,” and the plural form of these terms are used interchangeably throughout herein to refer to those who would access, use, and/or benefit from the tool that the invention provides.

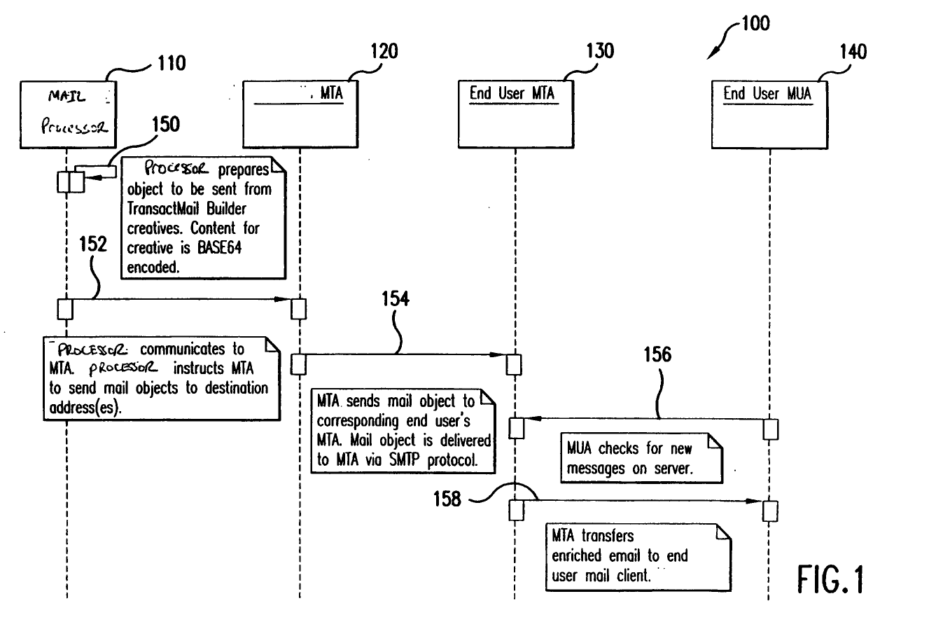

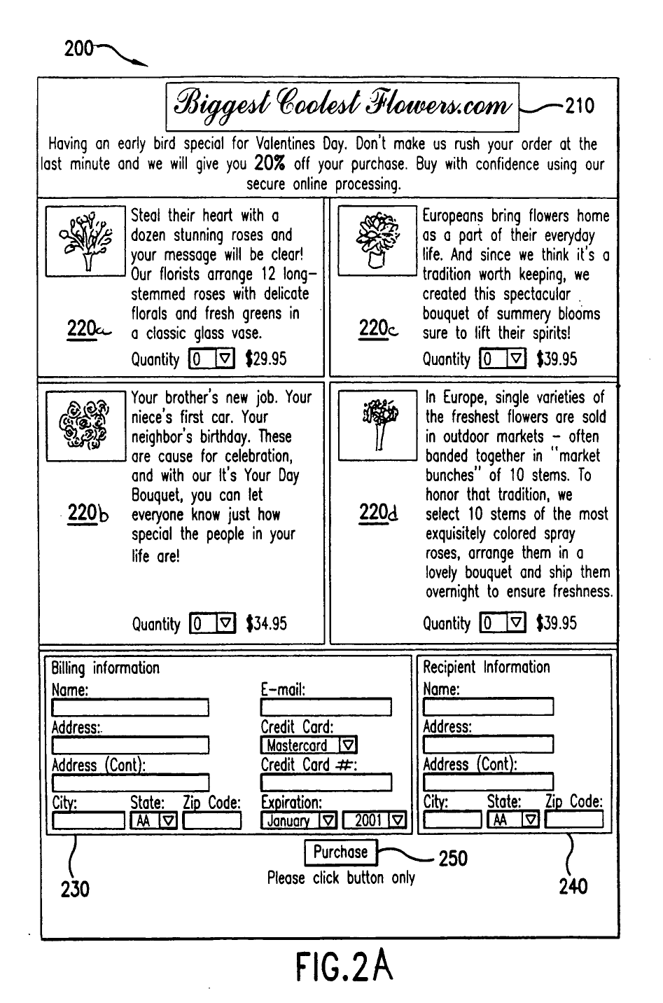

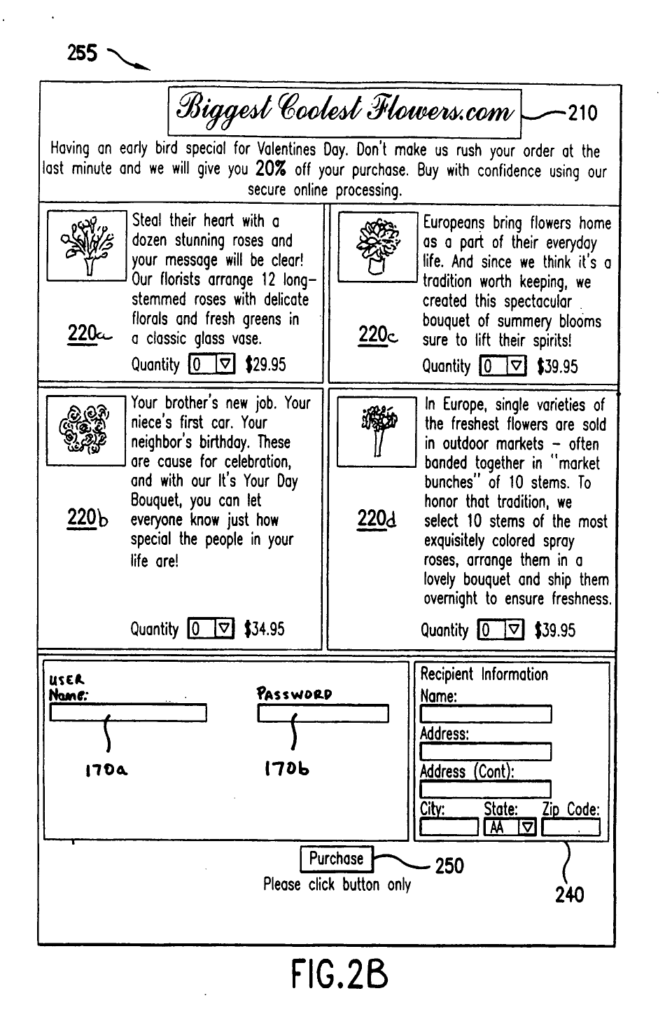

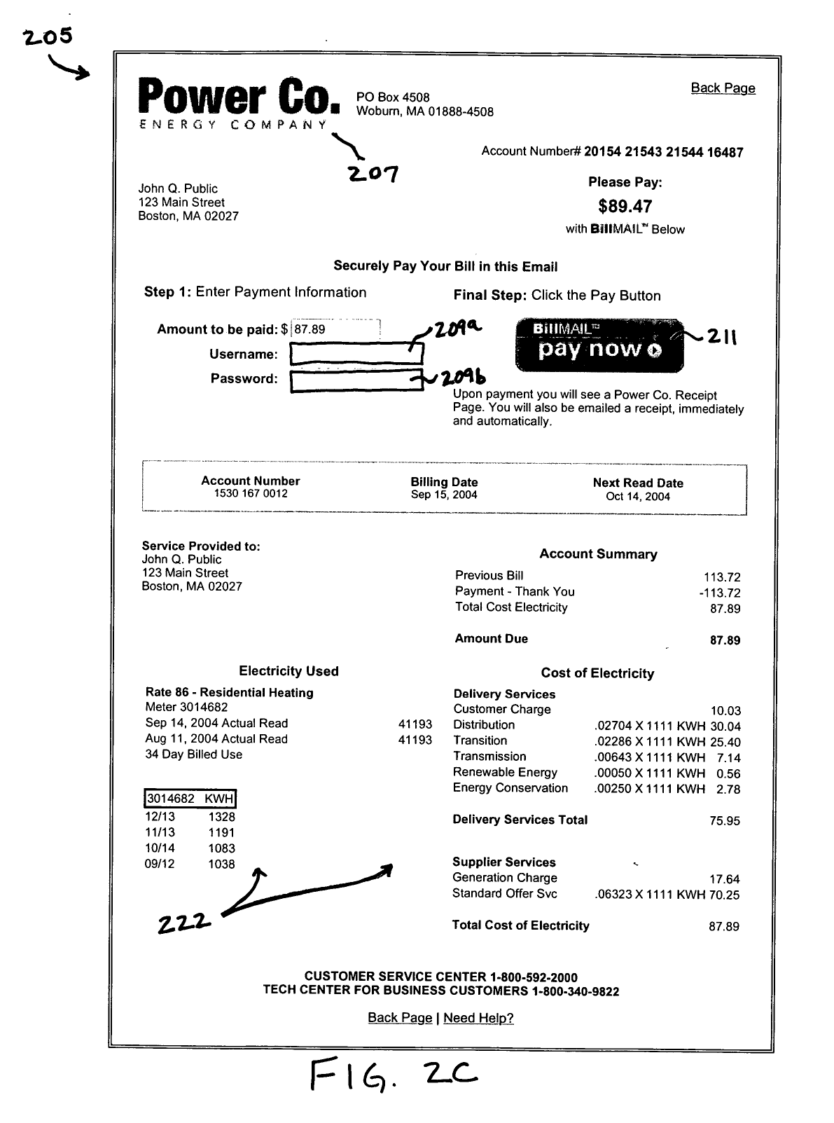

Referring to FIG. 1, an e-mail creation and transfer process 100, according to an embodiment of the invention, is shown. Process 100 (i.e., sequence of steps 150-158) begins at step 150, where an electronic mail message object is composed at a processor 110. (An example of electronic mail message 200 is shown in FIG. 2 and is described in more detail below.) In an embodiment of the invention, e-mail 200 is composed using the Hyper Text Markup Language (HTML) in a manner that is well known in the relevant art(s). In an alternate embodiment, Base 64 encoding is used in order to transmit any underlying (binary) encoding that forms e-mail 200 through certain text-only electronic mail systems.

After e-mail 200 has been composed, processor 110 transmits e-mail 200 to a mail transfer agent (i.e., an e-mail server) 120 along with the delivery destination(s) (i.e., e-mail addresses) at step 152. The mail transfer agent (MTA) 120 then sends e-mail 200 to the specified destination(s), including at least one end user mail transfer agent 130 at step 154. In an embodiment of the invention, step 154 is accomplished using the Simple Mail Transfer Protocol (SMTP). The text of e-mail 200 can be prepared in HTML format and transmitted as an attachment to a secure e-mail. E-mail 200 is then stored at end user mail transfer agent 130 until the end user's mail user agent 140 (e.g., Microsoft® Outlook® Express or the like) checks for new messages at step 156. Then, e-mail 200 is sent from end user mail transfer agent 130 to end user mail user agent (MUA) 140, where it is viewed by the customer at step 158.

Referring to FIG. 2A, an electronic mail message object (or simply, “e-mail”) 200, according to an embodiment of the invention, is shown. E-mail 200, which in this example, flowers are offered for sale, includes a field 210 that displays the name of the merchant. A plurality of fields 220 display the good(s) and/or service(s) being offered for sale. E-mail 200, in this example, includes four different flower arrangements (i.e., fields 220a-d) being offered for sale. In some embodiments of the invention, the number of different good(s) and/or service(s) is kept small (e.g., 1 to 5), although the inclusion of a larger numbers of good(s) and/or service(s) is also within the scope of the invention.

E-mail 200 also includes a billing information area 230 into which a consumer receiving the e-mail may enter billing information such as name, address, and credit card information. E-mail 200 further includes a recipient information area 240, which may be used to enter shipping information in the event that it is different from the billing information. Finally, e-mail 200 includes a Purchase “button” or indicia 250, which the consumer may press to accept the offer and complete the transaction contemplated by e-mail 200. As used herein, the term “button” is used in a generic sense and should be understood to refer to any input mechanism, now known or later developed, by which a customer can indicate a desire to accept a proposed offer and thus, complete a commercial transaction.

Referring to FIG. 2B, in an alternative embodiment of the invention, an e-mail 255 is transmitted to a consumer instead of e-mail 250. The e-mail 255 includes a first field 270a and a second field 270b into which a consumer receiving the e-mail 255 may enter a username and a password. E-mail 255 further includes a recipient information area 240, which may be used to enter shipping information. Finally, e-mail 255 includes a Purchase “button” or indicia 250 as described above, which the consumer may press to accept the offer and complete the transaction contemplated by e-mail 255.

The username and password are uniquely associated with a particular user or a particular customer identification code. The username and password are securely transmitted as discussed herein, and are mapped to a database of information that includes information about the user. For example, the information about a particular user can be included in a user account that includes the user's name, address, telephone number, e-mail address, credit card number, bank account number, etc. When a user provides their username and password, the information in the database can be used to complete a transaction as described herein. In other words, to complete a given transaction, the user need only enter their username and password rather than all of the information typically required for such a transaction (i.e., address, credit card number).

The user account can be established by the user prior to entering into the transaction. For example, in the context of a bill payment service, the user provides the billing entity with, for example, their bank account information, address, phone number, etc. prior to completing the e-mail transaction. Once the username and password are transmitted to the billing entity, the username and password are mapped to the user account to obtain the necessary payment information.

Referring to FIG. 2C, an electronic mail message object (or simply, “e-mail”) 205, according to a further embodiment of the invention, is shown. E-mail 205, which in this example is a bill from a utility company, includes a field 207 that displays the name of the billing entity. A plurality of fields 222 display the service(s) rendered by the billing entity or other charges for which the customer is being billed. E-mail 205, in this example, a bill from a power company that notes the electricity used and the cost of the usage. In some embodiments of the invention, the services and/or charges are not listed in detail, but rather are simply summarized in the e-mail 205.

E-mail 205 also includes a first field 209a and a second field 209b into which a consumer receiving the e-mail 205 may enter a username and a password. E-mail 205 further includes payment amount field 209c, which may be used to indicate the amount to be paid to the billing entity. Finally, e-mail 205 includes a “Pay Now” button or indicia 211 as described above, which the consumer may press to complete the transaction contemplated by e-mail 205.

As discussed above, the username and password are uniquely associated with a particular user or a particular customer identification code. The username and password are securely transmitted as discussed herein, and are mapped to a database of information that includes information about the user. As discussed above, the text of e-mail 200 can be prepared in HTML format and transmitted as an attachment to a secure e-mail.

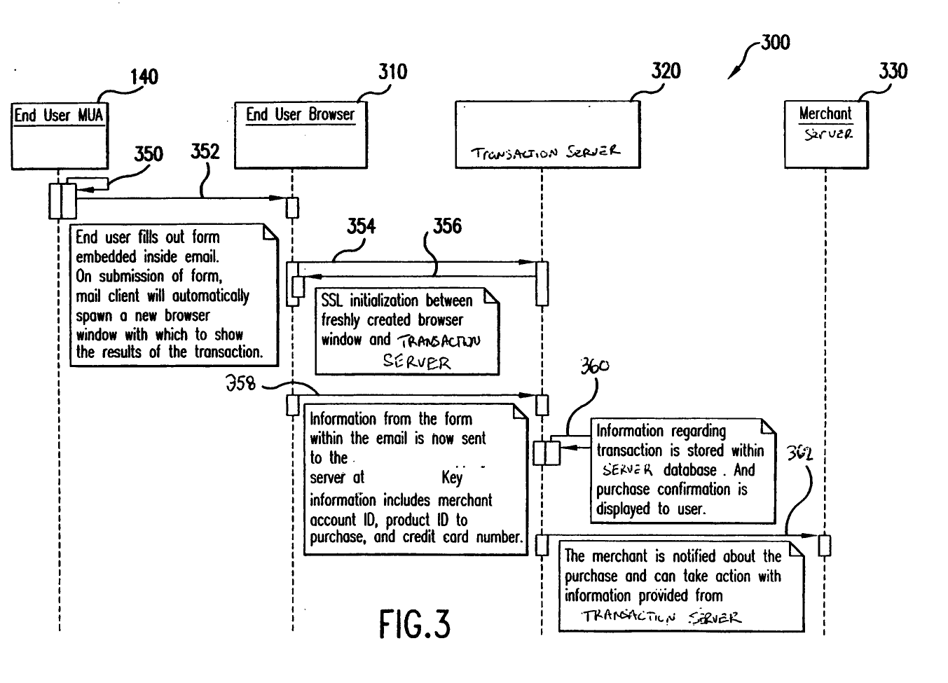

Referring to FIG. 3, an e-mail launched web transaction process 300, according to an embodiment of the invention, is shown. Process 300 (i.e., sequence of steps 350-362) begins when a consumer/e-mail recipient views e-mail 200 or 255 and decides to purchase any of the offered good(s) and/or service(s).

In step 350, the consumer enters any required information depending on the type of e-mail received (e.g. for e-mail 250, name, address and credit card number and for e-mail 255 username and password), any required shipping information in shipping information area 240, and any other required/desired information (e.g., quantity of items ordered, etc.).

In step 352, when the consumer clicks or otherwise actuates Purchase button 250, mail user agent 140 spawns a new browser window 310 (which in some embodiments, is visible to the consumer). The spawning of new browser window 310 includes a HyperText Transmission Protocol, Secure (HTTPS) Uniform Resource Locator (URL) request for a secure transaction server 320.

As a result of step 352, browser window 310 initiates SSL handshaking and certificate exchange with transaction server 320 at steps 354 and 356. A secure communications channel is thereby established. In step 358, once the secure communications channel has been established, the information previously entered by the customer in step 350 is sent from browser window 310 to transaction server 320. In some embodiments, when the user transmits only a username and password, the username and password are mapped to the database of information described above that contains other information (e.g., billing information) in a step 355.

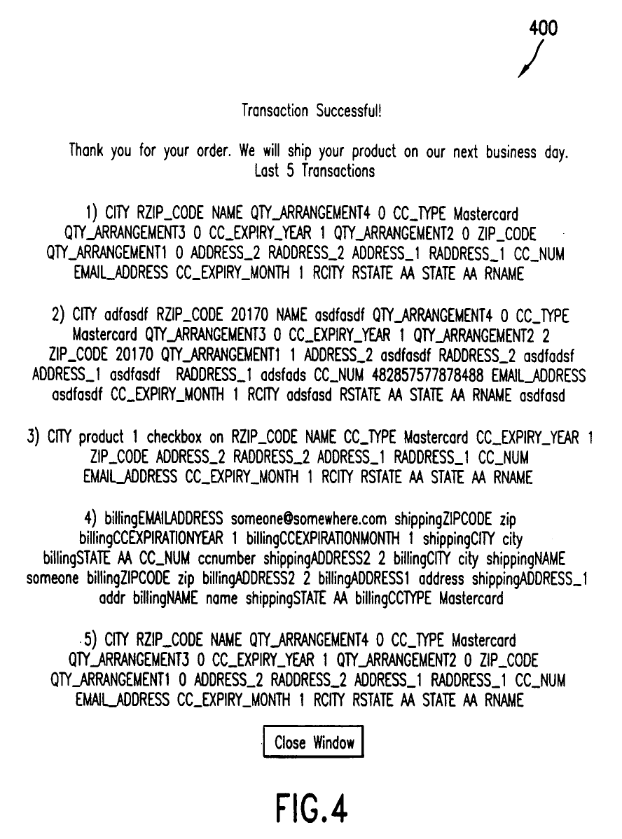

In step 360, transaction server 320 then stores the transaction in a database located on, or accessible to, server 320. Next, a confirmation 400 (shown in FIG. 4) of the transaction is downloaded to browser window 310. Finally, at step 362, merchant server 330 is notified of the transaction and takes the appropriate action to execute the transaction for the purchased good(s) and/or service(s) based on the (billing and shipping) information previously provided by the customer in step 350 and/or step 355.

It should be understood that the screens shown herein for e-mail 200, e-mail 255 and confirmation 400, which highlight the functionality of the invention, are presented for example purposes only. The invention is sufficiently flexible and configurable such that consumers may receive e-mails or see displayed windows other than the ones shown in FIG. 2A, 2B and FIG. 4.

In the embodiment of FIG. 3 discussed above, transaction server 320 and merchant server 330 are illustrated as separate physical components. Such an arrangement allows for a marketing entity (or service provider) to act as a “middle man” between consumers and merchants selling good(s) and/or service(s). In such an embodiment, the need for any modification to the merchant's Web site to implement the invention is eliminated. Further, this provides the opportunity for a fee to be collected by the service provider for all transactions forwarded to merchant server 330. Such a fee might be collected as a result of the service provider having prepared and/or sent e-mail 200. In other embodiments, where the merchant directly implements the invention, browser window 310 communicates directly with the merchant server 330, thereby “cutting out the middle man” (i.e., server 320).

In alternative embodiments, the functions of other components shown as separate, may be performed by the same physical device. For example, the functions performed by mail transfer agent 120 and transaction server 320 may be performed by a single server. Those of skill in the art will recognize that other combinations of functions are similarly possible.

As mentioned above, new browser window 310 is visible to the consumer when it is spawned in step 352. One of the reasons new browser window 310 is opened is to take advantage of the built-in support for SSL/TLS secure channels provided by most current browsers such as Microsoft® Internet Explorer, Netscape® Navigator and the like. This is done because most current mail user agents 140 (e.g., Microsoft® Outlook®, Eudora® and the like) do not support such secure channels although they support the display of HTML documents.

In an alternative embodiment of the invention, new browser window 310 is hidden from the recipient. In such an embodiment, confirmation of the transaction could be provided by way of a separate e-mail from transaction server 320 (or merchant server 330) to mail user agent 140, rather than through the download of a confirmation Web page 400 to new browser window 310. The need for new browser window 310, however, may be eliminated entirely if mail user agent 140 is equipped to support secure channel communications.

From the point of view of the consumer, with the exception of entering the information discussed above in connection with step 350, which is done “in the e-mail” (i.e., the consumer enters the information in the same window in which e-mail 200 or e-mail 255 is displayed by mail user agent 140), the entire transaction is completed with a single click or activation of Purchase button 250. There is no need for the consumer to actually visit a merchant's Web site. Further, prior to viewing e-mail 200 and activating Purchase button 250, there is no need for the consumer to even open a browser window. Thus, the process of the invention facilitates the online ordering of a desired good or service in comparison to known methods.

Consumers can be required to enter identification information such as username and password or name and address as discussed above. In alternative embodiments, where individualized e-mails are sent to targeted consumers (e.g., from an e-mail list purchased by the merchant from a third-party, or a database of the merchant's existing customers), the information in areas 230, 240, 270a, 270b may be pre-populated (i.e., inserted into the e-mail in advance). Such an alternative embodiment is described below.

In other embodiments of the invention, e-mails sent to a merchant's existing customers may include a customer identification (ID) code which is transmitted to transaction server 320 when a “Purchase Using Default Options” button is activated within e-mail 200. In such embodiments, only the customer ID code is sent to the merchant because they already possess the billing and shipping information needed to complete the transaction. If the default information is correct, the entire transaction may be completed with one simple click. The e-mails in such an embodiment may also provide the customer with the opportunity to modify the default (e.g., shipping) information.

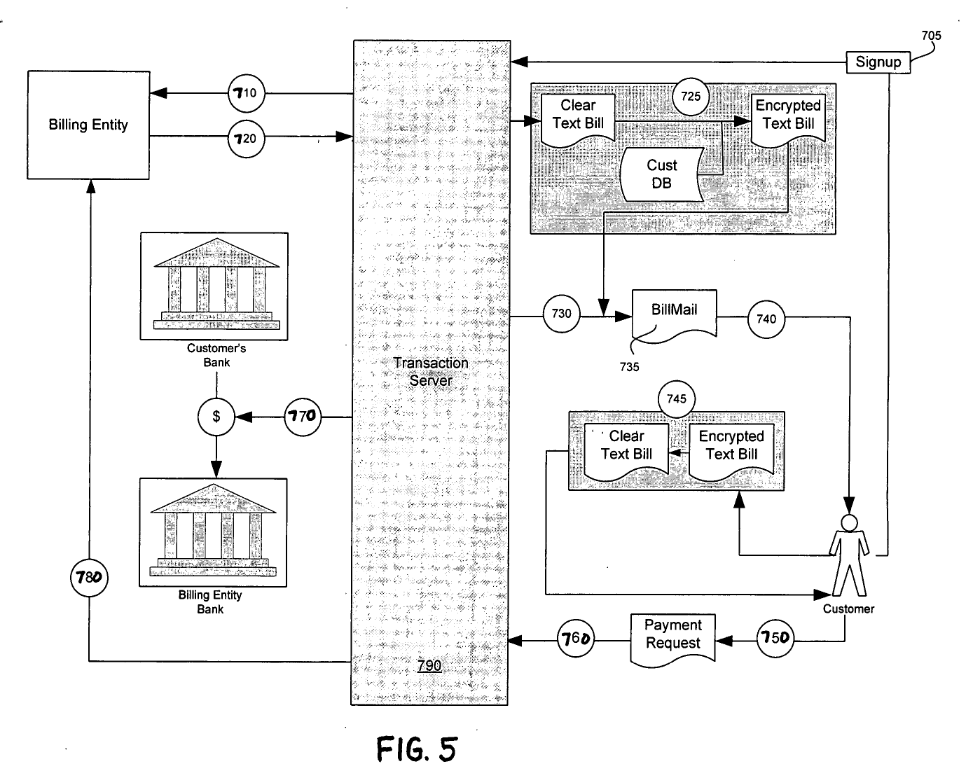

Referring to FIG. 5, a flow diagram illustrating a further embodiment of the invention is provided. In the illustrated embodiment, a customer signs up in a step 705 for a bill payment service via an e-mail, a website, telephone, etc. The customer provides relevant information to a transaction server 790 to create a customer account. The customer account includes, for example, bank information, name, address, telephone number, credit card number, etc.

In a step 710, a third party billing entity (e.g., a utility company, a merchant, a credit card company, a subscription provider, a cable or satellite television provider) receives a list of customers from the transaction server 790. The information can be received according to the customer's account number, name, or other unique identifier. In a step 720, the third party billing entity sends billing information (e.g., bill amount due, due date, late fees) associated with the particular customer to the transaction server 790. In a step 725, the transaction server 790 receives the billing information from the billing entity for a particular customer. The billing information received from the billing entity can be encrypted or unencrypted.

Once the transaction server receives the billing information from the billing entity, the transaction server matches the billing information for the particular customer with a unique encryption key for that customer. The billing information and the encryption key are processed to produce an encrypted bill to be sent to the customer. The encrypted bill is forwarded to a customer as an attachment to an e-mail 735. The e-mail 735 is created in step 730 in a manner similar to that described above with respect to FIG. 1. In step 740, the e-mail 735 is forwarded to the appropriate customer.

In step 745, the customer receives and opens the encrypted e-mail attachment. The encryption key is supplied by the customer and the bill is decrypted and displayed to the customer for review. The encryption and decryption of the attachment to e-mail 735 is accomplished using known methods.

In a step 750, the customer actuates a “button” similar to that described above with respect to FIGS. 2A and 2B to authorize the transaction server 790 to make a payment. In step 760, the authorization is sent to the transaction server 790. In step 770, the transaction server transfers funds to the billing entity's bank as payment for the bill. In step 780, the transaction server provides payment information to the billing entity.

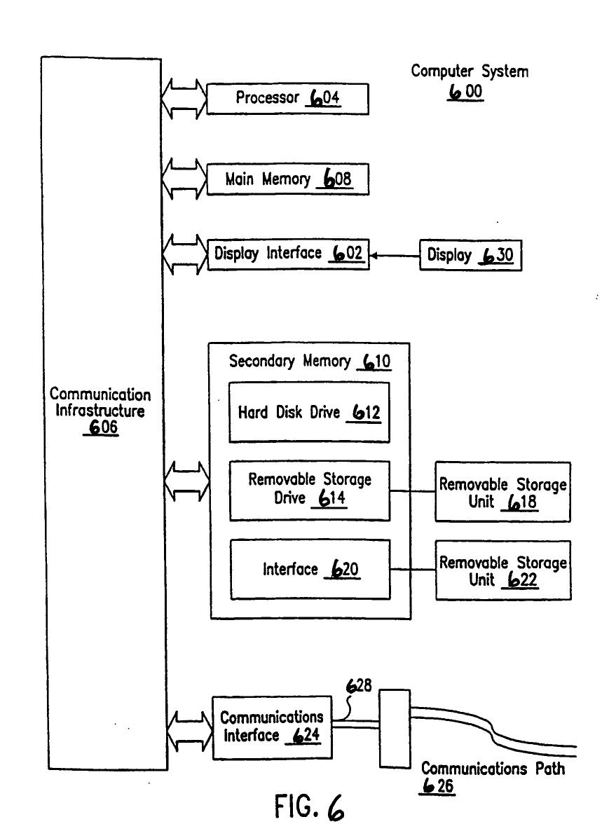

The invention may be implemented using hardware, software or a combination thereof and may be implemented in one or more computer systems or other processing systems. In some embodiments, the invention is directed toward one or more computer systems capable of carrying out the functionality described herein. An example of a computer system 600 is illustrated in FIG. 6. The computer system 600 includes one or more processors, such as processor 604. The processor 604 is connected to a communication infrastructure 606 (e.g., a communications bus, cross-over bar, or network). Various software embodiments are described in terms of this example of a computer system. It will become apparent to a person skilled in the relevant art(s) how to implement the invention using other computer systems and/or architectures.

Computer system 600 can include a display interface 602 that forwards graphics, text, and other data from the communication infrastructure 606 (or from a frame buffer not shown) for display on the display unit 630.

Computer system 600 also includes a main memory 608, preferably random access memory (RAM), and may also include a secondary memory 610. The secondary memory 610 may include, for example, a hard disk drive 612 and/or a removable storage drive 614, representing a floppy disk drive, a magnetic tape drive, an optical disk drive, etc. The removable storage drive 614 reads from and/or writes to a removable storage unit 618 in a well known manner. Removable storage unit 618, represents a floppy disk, magnetic tape, optical disk, etc. which is read by and written to by removable storage drive 614. As will be appreciated, the removable storage unit 618 includes a computer usable storage medium having stored therein computer software and/or data.

In alternative embodiments, secondary memory 610 may include other similar devices for allowing computer programs or other instructions to be loaded into computer system 600. Such devices may include, for example, a removable storage unit 622 and an interface 620. Examples of such may include a program cartridge and cartridge interface (such as that found in video game devices), a removable memory chip (such as an erasable programmable read only memory (EPROM), or programmable read only memory (PROM)) and associated socket, and other removable storage units 622 and interfaces 620, which allow software and data to be transferred from the removable storage unit 622 to computer system 600.

Computer system 600 may also include a communications interface 624. Communications interface 624 allows software and data to be transferred between computer system 600 and external devices. Examples of communications interface 624 may include a modem, a network interface (such as an Ethernet card), a communications port, a Personal Computer Memory Card International Association (PCMCIA) slot and card, etc. Software and data transferred via communications interface 624 are in the form of signals 628 which may be electronic, electromagnetic, optical or other signals capable of being received by communications interface 624. These signals 628 are provided to communications interface 624 via a communications path (e.g., channel) 626. This channel 626 carries signals 628 and may be implemented using wire or cable, fiber optics, a telephone line, a cellular link, an radio frequency (RF) link and other communications channels.

In this document, the terms “computer program medium” and “computer usable medium” are used to generally refer to media such as removable storage drive 614, a hard disk installed in hard disk drive 612, and signals 628. These computer program products provide software to computer system 600. The invention is directed to such computer program products.

Computer programs (also referred to as computer control logic or code) are stored in main memory 608 and/or secondary memory 610. Computer programs may also be received via communications interface 624. Such computer programs, when executed, enable the computer system 600 to perform the features of the invention, as discussed herein. In particular, the computer programs, when executed, enable the processor 604 to perform the features of the invention. Accordingly, such computer programs represent controllers of the computer system 600.

In an embodiment where the invention is implemented using software, the software may be stored in a computer program product and loaded into computer system 600 using removable storage drive 614, hard drive 612 or communications interface 624. The control logic or code (software), when executed by the processor 604, causes the processor 604 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

### CONCLUSION

While various embodiments of the invention have been described above, it should be understood that they have been presented by way of example only, and not limitation. Thus, the breadth and scope of the invention should not be limited by any of the above-described embodiments, but should be defined only in accordance with the following claims and their equivalents.

The previous description of the embodiments is provided to enable any person skilled in the art to make or use the invention. While the invention has been particularly shown and described with reference to embodiments thereof, it will be understood by those skilled in art that various changes in form and details may be made therein without departing from the spirit and scope of the invention.

1. A method, comprising:
transmitting to a processor, an e-mail including a description of an offer and a selectable indicia, the actuation of which is configured to indicate acceptance of the offer in response to actuation of the selectable indicia; and
receiving, via a browser, an indication of acceptance of the offer at a transaction server in response to an actuation of the selectable indicia.

2. The method of claim 1, further comprising:
transmitting, to the processor, a confirmation of receipt of the indication by the transaction server.

3. The method of claim 2, wherein the confirmation is transmitted via the browser.

4. The method of claim 2, wherein the e-mail is a first e-mail and the confirmation is transmitted in a second e-mail.

5. The method of claim 1, further comprising establishing a secure communications channel between the browser and the transaction server.

6. The method of claim 1, the e-mail including a plurality of fields configured to receive customer information, the customer information including at least a username or a password, the method further comprising:
receiving the customer information at the transaction server.

7. The method of claim 6, wherein the customer information is received by the transaction server via the browser.

8. The method of claim 6, wherein the customer information is received via the secure communications channel.

9. The method of claim 6, further comprising mapping the username and the password to a database associated with the transaction server, the database including additional customer information, the additional customer information being at least one of a customer code, a credit card number, a bank account number, a customer name, a customer billing address or a customer phone number.

10. The method of claim 6, wherein at least one of the plurality of fields is populated with the username prior to transmitting of the email to the computer.

11. The method of claim 1, further comprising:
transmitting the indication of acceptance of the offer from the transaction server to a merchant server.

12. A method, comprising:
sending an email including an offer, a visual indicia configured to cause an indication of acceptance of an offer by actuation of the indicia, a first field configured to allow input of a username and a second field configured to allow input of a password, the indicia being configured to cause a browser to be spawned in response to actuation of the indicia, the indicia being further configured to cause the browser to establish a secure communications channel between the browser and a transaction server;
if the indicia is actuated, receiving an indication of acceptance of the offer in response to the actuation of the indicia;
if the first field and second field are populated, receiving the user name and password at the transaction server via the secure communications channel; and
mapping the username and the password to a database, the database including customer information uniquely associated with the username and the password, the customer information being at least one of a customer code, a bank account number, a credit card number, a customer name, a customer billing address or a customer phone number.

13. The method of claim 12, further comprising transmitting the customer information from the transaction server to a merchant server.

14. The method of claim 12, wherein the first field is automatically populated with the username.

15. A processor-readable medium storing code representing instructions to cause a processor to perform a process, the code comprising code to:
send an email including an offer, a visual indicia configured to cause an indication of acceptance of an offer by actuation of the indicia, a first field configured to allow input of a username and a second field configured to allow input of a password, the indicia being configured to cause a browser to be spawned in response to actuation of the indicia, the indicia being further configured to cause the browser to establish a secure communications channel between the browser and a transaction server;
if the indicia is actuated, receive an indication of acceptance of the offer in response to the actuation of the indicia;
if the first field and second field are populated, receive the user name and password at the transaction server via the secure communications channel; and
map the username and the password to a database, the database including customer information uniquely associated with the username and the password, the customer information being at least one of a customer code, a bank account number, a credit card number, a customer name, a customer billing address or a customer phone number.

16. The processor readable medium of claim 15, the code further comprising code to transmit the customer information from the transaction server to a merchant server.

17. A method, comprising:
receiving at a transaction server customer information to create a customer account;
transmitting a customer identification code to a billing entity, the customer identification code being associated with the customer account;
receiving billing information associated with the customer account from the billing entity;
transmitting the billing information to a customer; and
receiving from the customer an indication to make a payment to the billing entity, the indication being received in response to the customer actuating an indicia associated with the billing information.

18. The method of claim 17, wherein the transmitting the billing information includes transmitting the billing information to a customer as an attachment to an e-mail.

19. The method of claim 17, further comprising encrypting the billing information prior to transmitting the billing information to the customer.

20. The method of claim 17, further comprising transmitting payment information to the billing entity.
